(19) United States
(12) Patent Application Publication
(10) Pub. No.: US 2025/0216247 A1
(43) Pub. Date: Jul. 3, 2025

(54) VEHICLE LOAD WEIGHT ESTIMATION BASED ON OPERATING PARAMETERS OF THE VEHICLE

(71) Applicant: Intel Corporation, Santa Clara, CA (US)

(72) Inventors: Sean J.W. LAWRENCE, Bangalore (IN); Ramakrishna MADHAVA, Bangalore (IN); Robert L. VAUGHN, Portland, OR (US); Koney SAI KEERTHI, Bangalore (IN); Devesh VYAS, Bangalore (IN); Riyaz Chandasaheb GHATI, Bangalore (IN)

(21) Appl. No.: 18/961,504

(22) Filed: Nov. 27, 2024

Related U.S. Application Data
(63) Continuation of application No. PCT/US2023/086119, filed on Dec. 28, 2023.

(51) Int. Cl. G01G 19/08; G01G 19/03

(52) U.S. Cl. CPC G01G 19/08; G01G 19/03

(57) ABSTRACT

Disclosed herein are devices, methods, and systems for estimating a load weight of a vehicle without measuring the weight of the vehicle (e.g., without a weight sensor). The load weight estimation may obtain an engine torque and a velocity of a vehicle when it is in motion. The load weight estimation may then determine, based on the engine torque and the velocity, an estimate of a load weight on the vehicle. The load weight estimation may then generate an instruction based on the estimate of the load weight. The load weight estimation may also use other operating parameters of the vehicle, such as tire pressure, a pose, acceleration, geographic location, road geometry, ambient temperature, road conditions, engine temperature, etc. to determine the estimate of the load weight.

### CROSS-REFERENCE TO RELATED APPLICATION(S)

This application claims domestic priority to PCT Application No. PCT/US2023/086119 filed on Dec. 28, 2023, the contents of which are fully incorporated herein by reference.

### TECHNICAL FIELD

The disclosure relates generally to determine a load weight of a load on a vehicle, and in particular, to estimating the load weight of the vehicle using operating parameters of the vehicle such as the vehicle's engine torque and movement velocity.

### BACKGROUND

For vehicles that carry goods and people, it is often important to know the weight of the load that has been added to the vehicle. Knowledge of the load may be helpful for various purposes such as vehicle safety (e.g., to prevent overloading), load-based monetization (e.g., to maximize the amount of cargo by available weight), and government regulations (e.g., to comply with road weight limits or pay tolls for the use of a road based on weight). Understand in the load weight of the vehicle may be particularly important in developing countries, where unauthorized loading of the vehicle and transport of unauthorized goods may be prevalent and more strictly scrutinized. As should be appreciated, government jurisdictions may impose fines for driving an overloaded vehicle on roads, vehicles may be subject to tolls based on the weight of the load, and overloaded vehicles may cause damage to roads/infrastructure and increase the safety-related risks of operating the vehicle.

Typical solutions to monitor the load on a vehicle are to add weight sensors on the vehicle (e.g., on the cargo bed of the vehicle, on the flat portion of the trailer carrying the load, and/or at the vehicle's axle(s) to measure the load on the vehicle. These sensors add extra bill-of-material costs at the time of manufacturing the vehicle, and if such sensors are not added at the time of manufacturing, it may not be possible or may be too expensive to be added after-market. For vehicles that do not include weight sensors, measuring the load weight often requires a large weighing scales that is capable of weighing the entire vehicle together with its load, which may require specialized infrastructure (e.g., a large-format and heavy-duty scale) at fixed locations.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an example of load weight estimation that may be based on operational data about the vehicle and static information about the environment instead of sensors that measure the weight of the load;

FIG. 2 shows an exemplary graph of engine power over time, where the transitional period of the change in engine power may be informative as to the load weight of the vehicle;

FIG. 3 illustrates an exemplary graph of acceleration of the vehicle over time, where the transitional period of the change in acceleration may be informative as to the load weight of the vehicle;

FIG. 4 depicts an exemplary trailer sensor system may include pressure sensors for measuring forward or reverse pressures on the hitch;

FIG. 5 shows an example of a map display that may indicate different weight change alerts for the load weight at different points in time for a vehicle at different locations;

FIG. 6 shows an exemplary schematic drawing of a device for load weight estimation of a vehicle that may be based on operational data instead of on weight sensor data of the weight of loaded vehicle; and

FIG. 7 depicts a schematic flow diagram of an exemplary method for load weight estimation of a vehicle that may be based on operational data instead of on weight sensor data of the weight of the loaded vehicle.

### DESCRIPTION

The following detailed description refers to the accompanying drawings that show, by way of illustration, exemplary details and features.

The word “exemplary” is used herein to mean “serving as an example, instance, or illustration.” Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in the form of a pointer. The term “data”, however, is not limited to the aforementioned examples and may take various forms and represent any information as understood in the art.

The terms “processor” or “controller” as, for example, used herein may be understood as any kind of technological entity (e.g., hardware, software, and/or a combination of both) that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, software, firmware, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as radio frequency (RF) transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both “direct” calculations via a mathematical expression/formula/relationship and ‘indirect’ calculations via lookup or hash tables and other array indexing or searching operations.

A “vehicle” may be understood to include any type of driven object. By way of example, a vehicle may be a driven object with a combustion engine, a reaction engine, an electrically driven object, a hybrid driven object, or a combination thereof. A vehicle may be or may include an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, or a rocket, among others. A vehicle may include objects that that can be driven without a driver or partially driven without a driver (e.g., an autonomous or partially autonomous vehicle).

As noted above, for vehicles that do not include specialized weight sensors built into the vehicle (e.g., on the cargo bed, in the axels, etc.), determining the weight of the load often requires a large weighing scale that is capable of weighing the entire vehicle together with its load, which may require specialized infrastructure (e.g., a large-format and heavy-duty scale) at fixed locations. Or, weight sensors must be added to the vehicle after-market, which may be impossible or expensive.

To overcome this problem, discussed in more detail below is a method to estimate the added load on the vehicle based on vehicle operating parameters that are collected from sensor information that is already available in a typical vehicle (e.g., without the need for a specialized weight sensor or other load-specific sensor), where such vehicle operating parameters may include engine parameters and other information that may be accessed through the vehicle's controller area network (CAN bus). The load weight estimates may then trigger alerts (e.g., a weight-change alert) and/or may be provided off-vehicle to a fleet monitoring entity that may monitor the vehicle load (e.g., to ensure compliance with weight restrictions and/or to optimize load-based monetization). Such a weight estimation method may be applied to existing vehicles (e.g., via a software update) and as an original equipment manufacturer (OEM) solution, without having to add weight sensors (e.g., increasing bill of materials (BOM) costs) and without having to add additional points of failure (e.g., an additional weight sensor may be an additional point of failure).

The disclosed method for estimating the weight of a load on a vehicle may determine load weight based on engine parameters such as a torque on the engine and a movement velocity of the vehicle. For example, the load weight estimation method may relate the engine's current output power and vehicle's current velocity to a given load weight or to a total vehicle weight (e.g., unladen vehicle plus load). Parameters such as engine power and velocity are typical parameters that may already be available on a vehicle's CAN bus, accessible via an on-board diagnostic (OBD) port, for example. The relationship may also be based on other vehicle parameters, which may be fixed, estimated, measured, or determined in real time. For example, a tire pressure may be used as a factor in the relationship. As another example, an accelerometer, inertial measurement unit (IMU), global-positioning-system (GPS)/map data, etc. may be used as a factor, where road geometry may impact the relationship between load weight estimation and the operating parameters of the vehicle. Moreover, this information from the vehicle's operating parameters may be used to ensure that estimates are performed at optimal times (e.g., on relatively straight/level sections of the road).

The load weight estimation method may also check other vehicle operating parameters to ensure they are within generally expected ranges (e.g., the engine is running normally and there are no engine anomalies, such as low oil, unexpected pressure, gasket leaks, etc., the tires are inflated within the correct range, the incline of the vehicle is within a proper range, etc.). If the operating parameters are not within the generally expected ranges, the load weight estimation may not be performed, a warning message may be issued, and/or the load weight estimation may be provided with a caveat (e.g., an error margin or degree of uncertainty). If the operating parameters are within the generally expected ranges, the engine's current output power (e.g., current horsepower (HP)), torque, and/or velocity may be calculated and/or obtained from information available about the vehicle operating parameters from the CAN bus (e.g., from OBD data).

Then, the total actual weight of the vehicle (e.g., which includes the weight of the empty vehicle plus its current load) may be determined and then the empty vehicle weight (e.g., obtained from manufacturing specifications, a predetermined value, etc.) may be subtracted to estimate the weight of the load. As should be appreciated, the load weight estimate may be calculated as a discrete number or as being within a range, which may be saved/reported to a user (e.g., as an approximate value or as a range/grouping (e.g., “overloaded”, “moderately loaded”, “lightly loaded”, “not loaded/unladen”), etc.)

An example relationship that relates a vehicle's horse power (HP) with torque and velocity (speed) may be given by:

$$HP = \frac{( torque \times velocity )}{5252} .$$

An example relationship that relates horse power (HP) with weight and velocity (speed) may be given by:

$$HP = weight \times {( \frac{velocity}{234} )}^{2} .$$

Applying the above two relationships may mean that the overall weight of the vehicle (e.g., the vehicle's unladen weight plus the weight of its load) may be found by dividing the torque value by the velocity multiplied by a factor

$$( e . g . , \frac{torque}{velocity} \times \frac{{234}^{2}}{5252} ) .$$

While the factor in the exemplary equation above is a constant

$$( \frac{{234}^{2}}{5252} \approx 10 ) ,$$

this factor could be a function that varies based on any number of environmental conditions and operating parameters of the vehicle. As should also be appreciated, the above relationships are merely exemplary, and other relationships may be used that account for other factors.

For example, the variations in driving conditions, the way the driver is currently handing the vehicle, a tire pressure of the vehicle, a pose of the vehicle, an acceleration of the vehicle, a geographic location of the vehicle, a road geometry of a road on which the vehicle is operating, an ambient temperature around the vehicle, a road condition of the road on which the vehicle is operating, and an engine temperature of the vehicle, etc., may all impact the load weight estimate and the method may take these factors into account. The load weight estimate may, for example, average-out these variations or may utilize other vehicle operating parameters and static data to adjust the relationship. In addition, the method may identify significant changes in the loaded weight in order to determine points at which the load/cargo may have been added, removed, or changed.

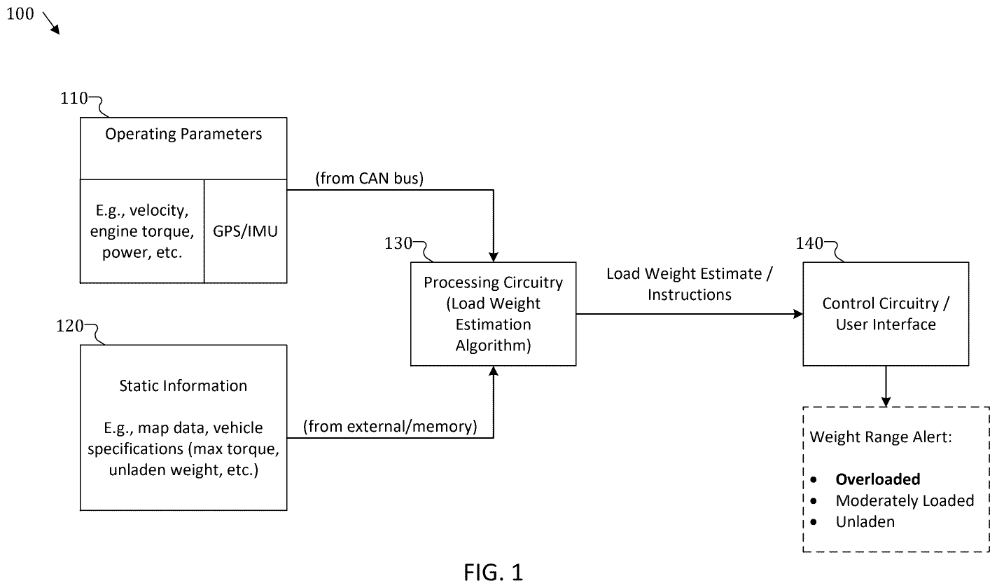

FIG. 1 shows an example of load weight estimation 100 that may be based on vehicle information (e.g., operational data and static information about the environment and vehicle) instead of sensors that measure the weight of the load. Operating parameters 110 may be obtained from the vehicle and provided to processing circuitry 130 for estimating the load weight of the vehicle based on the operating parameters 110. The operating parameters 110 may include engine parameters such as a torque on the engine and a movement velocity of the vehicle. For example, the processing circuitry 130 may relate the engine's current output power and vehicle's current velocity to a given load weight or to a total vehicle weight (e.g., unladen vehicle plus load). Parameters such as engine power and velocity may be provided from the vehicle's CAN bus, for example, accessible via an on-board diagnostic (OBD) port. Example relationships are discussed and shown as an example in the equations above.

Processing circuitry 130 may also receive other operating parameters 110 or other static information 120, which may be fixed (e.g., static), estimated, measured, or determined in real time. For example, the vehicle may maintain a real-time tire pressure of the tires of the vehicle, and the actual tire pressure may be used to adjust the weight calculation (e.g., as a normalization factor for normalizing the estimate of the load weight based on, for example, the tire pressure or other operating parameters 110 or other static information 120). As another example, the processing circuitry 130 may use an accelerometer, inertial measurement unit (IMU), global-positioning-system (GPS)/map data, etc. as a factor in the weight calculation, as the pose of the vehicle and road geometry may impact the relationship between load weight estimation and the operating parameters of the vehicle (for example, a vehicle may use higher power to ascend up an inclining road and lower power to descend down a declining road, even though in both cases, the load weight is the same). A machine learning model may be used in processing circuitry 130 that relates any of the operating parameters 110 and the static parameters 120 to an estimated load weight. For example, the engine torque and the velocity may be inputs into the machine learning model of processing circuitry 130 which may provide, as an output from the machine learning model, the estimate of the load weight.

As should be understood, any of the operating parameters 110 or static information 120 may be stored in a memory on the vehicle or may be provided externally (e.g., wirelessly, from a cloud-based server/network). For example, the vehicle's unladen weight may be stored in a memory of the vehicle or obtained via a communication connection to an external server that may provide the information (e.g., by make, model, VIN number, etc.).

As described above, processing circuitry 110 may check the vehicle's operating parameters 110 and static information 120 to ensure that they are within generally expected ranges (e.g., the engine is running normally and there are no engine anomalies, such as low oil, unexpected pressure, gasket leaks, etc., the tires are inflated within the correct range, the incline of the vehicle is within a proper range, etc.). For example, instead of adjusting the weight estimate to account for the current incline/decline, the processing circuitry 110 may estimate the load weight of the vehicle only when the vehicle is on a relatively straight/level section of the road. If the operating parameters are not within the predefined ranges or do not satisfy predefined criterion, the processing circuitry 110 may decline to perform the load weight estimation, may issue a warning message, and/or may provide the load weight estimation along with a caveat (e.g., an error margin or degree of uncertainty). If the current operating and static parameters satisfy the predefined criteria, the processing circuitry 130 may estimate the total weight of the vehicle from the operating parameters as discussed above. Then, the processing circuitry 110 may subtract the unladen vehicle weight (e.g., from the static information 120) from the total weight to obtain the weight of the current load. As should be appreciated, processing circuitry 130 may estimate the load weight as a discrete number and/or as being within a range, either numerically (e.g., 0-1000 kg, 2000-3000 kg, greater than 3000 kg, etc.) or categorically (e.g., “overloaded”, “moderately loaded”, “lightly loaded”, “not loaded/unladen”), etc.

Once the processing circuitry 110 has determined an estimate of the load weight (and/or the range/category within which it falls), it may provide this estimate along with instructions to control circuitry 140. The control circuitry may then, based on the load weight and/or instructions, adjust an operation of the vehicle or provide a message to the user/fleet owner regarding a change in the load weight. For example, the control circuitry 140 may limit the speed, acceleration, or turning radius of the vehicle based on the load weight. As another example, the control circuitry 140 may select a route for the vehicle based on the load weight (e.g., so that the route includes roads that allow for such load weights). As another example, the control circuitry 140 may provide an alert to a user (e.g., a weight-change alert) indicating the estimated load or the range within which it falls (e.g., “overloaded”, “moderately loaded”, unladen”, etc.). The control circuitry 140 may also or alternatively provide this information off-vehicle (e.g., to a fleet monitoring entity) that may be responsible for monitoring the vehicle load weight (e.g., to ensure compliance with weight restrictions and/or to optimize load-based monetization).

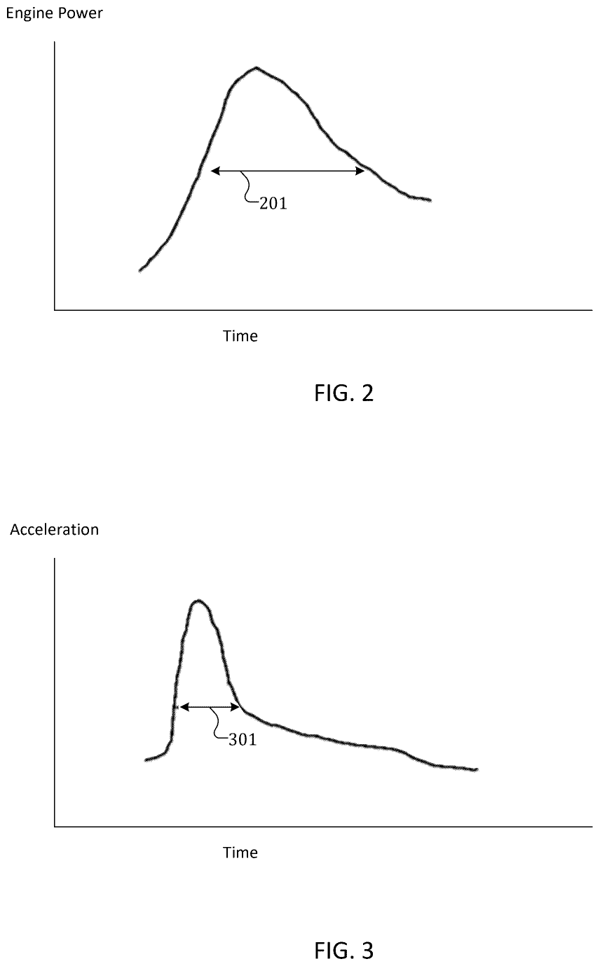

As another example of how operating parameters 110 and the static parameters 120 may be used to adjust the estimated load weight, the processing circuitry 130 may use transient data to improve the weight estimates. Two non-limiting examples are highlighted below: (1) an accelerometer analysis and (2) hitch sensor data analysis. In an accelerometer analysis, the processing circuitry 130 may use accelerometer data to determine a measure of the load that needs to be pulled by a single body vehicle or a trailer that the vehicle is towing. In the case of a trailer system, for example, there may be more than one set of accelerometer signals to be analyzed (e.g., one for the vehicle and one for the trailer). Additionally, this analysis of accelerometer data may be used in combination with other vehicle parameter data to adjust the load weight estimate (as discussed above). An example of the transient nature of the accelerometer analysis with respect to engine power is shown in the graphs of FIGS. 2 and 3. As shown in FIG. 3, there may be a transitional period 301 during which the acceleration changes quickly, and then levels out. The engine power may also exhibit a similar rise and fall, shown in the graph of FIG. 2, but the transitional period 201 may be longer than that of the acceleration. As should be appreciated, the processing circuitry 130 may use the transitional nature of the accelerometer signals in correlation with transitional nature of the engine power to refine the load weight estimation. For example, a large transitional period (e.g., the width of transition) may be indicative of the load weight, where larger widths may be indicative of larger loads and smaller widths may be indicative of smaller loads.

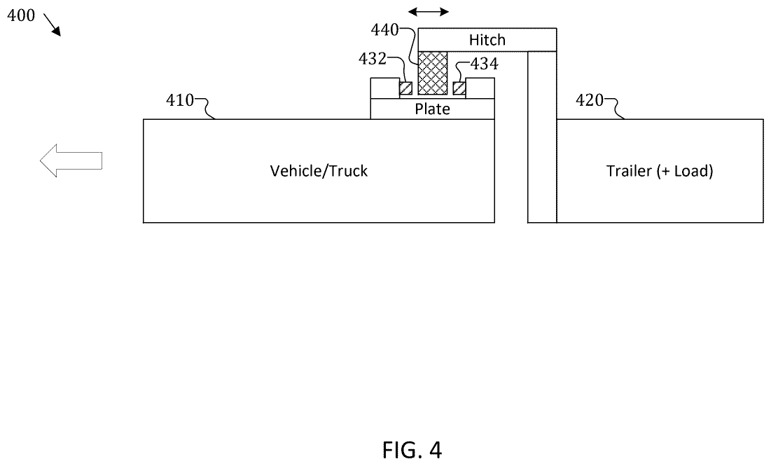

In a hitch sensor data analysis, the trailer system may include pressure sensors for measuring forward or reverse pressures on the hitch. An example of such a sensor system is shown in FIG. 4, where the vehicle 410 may include a plate for connecting to the pin 440 of a hitch of a trailer 420 (e.g., that may carry a load). The plate of the vehicle 410 may include one or more pressure sensors (e.g., pressure sensor 432 and/or pressure sensor 434) that may detect forward pressure (at pressure sensor 432) from the pin 440 when the pin 440 moves to the left or rearward pressure (at pressure sensor 434) when the pin 440 moves to the right, depending on whether the vehicle 410 is moving backwards (e.g., left to right on the sheet of FIG. 4) or whether the vehicle 410 is moving forwards (e.g., right to left on the sheet of FIG. 4). For example, when the vehicle 410 and trailer 420 are on level ground and the vehicle begins moving, pin 440 will move away from the vehicle, putting pressure on pressure sensor 434. The transitional pressure of pressure sensor 434 may be a measure of the weight of the load being pulled in the trailer. When the vehicle 410 and trailer 420 are on an upward-facing slope, however, there may be no transitions of the sensor as the pin 440 may already be exerting pressure on pressure sensor 434. When the vehicle 410 and trailer 420 are on a downward-facing slope, there may be transitions on pressure sensor 432, for example, as the pin 440 moves from being pushed by the trailer 420 towards vehicle 410 (when the vehicle 410 is stationary) to where the vehicle 410 begins pulling the trailer 420 when in motion. To determine which scenario the vehicle 410 and trailer 420 are in may be estimated from accelerometer signals as well as map data, where the map data may provide information as to slopes, direction, and other road geometries of the location of the vehicle 410.

As noted above, other information about the vehicle may also be used as a basis for estimating the load weight. For example, a machine learning algorithm may be used that relates any number of input parameters about the vehicle's operation to generate an estimated load weight. Below is a non exhaustive list of factors/parameters that may be obtained by the processing circuitry and taken into account when estimating the vehicle load weight:

| Factor | Consideration |
|---|---|
| Road complexity | The Road Complexity Score (RCS) of a particular road |
| (includes road | segment may be used to normalize the road complexity |
| surface, slope, | in the computation. This may be applied as an RCS- |
| etc.) | based coefficient in order to normalize the data. |
| | Additionally, RCS may also be used as a |
| | qualifier/disqualifier in order to disregard data on those |
| | road segments that are not relevant/reliable for |
| | estimating load weight. |
| Vehicle in need of | The relationship between torque and load estimates may |
| tune up | change based on the maintenance level of the vehicle. |
| | As a vehicle operates, the operation over time may cause |
| | gradual changes in the load weight estimates. Examples |
| | of service/maintenance levels may be oil pressure, oil |
| | quality, tire pressure, etc. This data, combined with |
| | correlation with OBD fault codes, may be used to adjust |
| | estimates of the load as the service parameters change. |
| | The rate of change of OBD codes, for example, may |
| | help determine if the vehicle state is due to gradual |
| | degradation, breakdown, etc., or due to a load weight |
| | change. |
| Temperature | Variations in temperature may be used to normalize load |
| | weight estimates using measured/estimated temperature |
| | values as compared to temperature values at which |
| | standard or calibrated engine data (or other sensor data) |
| | measurements are made. |
| Other slow | For changes to other parameters such as tire condition, |
| changing | pressure, and oil quality, the change is slow over time |
| parameters | and hence the impact on load weight estimates may be |
| | identified using OBD fault codes and performance over |
| | time and normalized accordingly. |

As noted above, the operating parameters may be used to normalize the estimation of the load weight. Variations in operating parameter values that may be due to other dependent factors (e.g., other than due to the load weight) may be normalized according to the following examples. Calibrated values may be those that are available as part of the vehicle specifications (e.g., from the static data about the vehicle).

Normalization coefficients may be derived for each dependent factor of a measured operating parameter. Proportional dependencies may be normalized as follows:

$$H = F ( Pm , Wm ) = Pm . Wm / Wc$$

In the formulas above, the variables are defined as:
Pm=measured parameter
Wm=measured directly proportional dependency
Wc=dependency value at calibrated parameter Pc
H=Resultant quantity
F=relationship function (simplest form is a relative multiplier)

Inversely proportional dependencies may be normalized as follows:

$$H = G ( Pm , Xm ) = Pm . Xc / Xm$$

In the formulas above, the variables are defined as:
Pm=measured parameter
Xm=measured indirectly proportional dependency
Xc=dependency value at calibrated parameter Pc
H=Resultant quantity
G=relationship function (simplest form is a relative multiplier)

From the two equations above, the various normalized coefficients may be combined as follows:

$$H = K ( Pm , Wm , Xm , … . ) = Pm . Wm / Wc . Xc / Xm$$

In the formulas above, the variables are defined as:
Pm=measured parameter
Wm=measured directly proportional dependency
Wc=dependency value at calibrated parameter Pc
Xm=measured indirectly proportional dependency
Xc=dependency value at calibrated parameter Pc
H=Resultant quantity
K=relationship function (simplest form is a relative multiplicative coefficients)

Further normalization may be done using other coefficients such as a road complexity score (RCS) discussed with respect to the table above.

In order to mature the algorithm, machine-learning algorithms may be used to predict translated values from calibrated values and measured dependencies. Vehicle data may be collected and aggregated centrally (e.g., at a fleet level) and used as training data to improve the accuracy of the estimates.

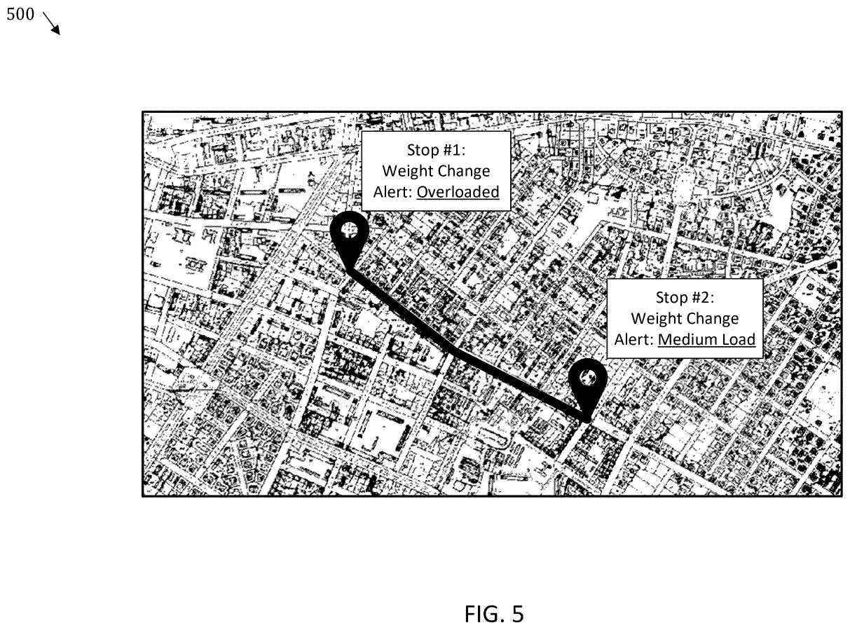

As should be appreciated, the load weight may be calculated on the vehicle or off the vehicle (e.g., on an external server/cloud platform) or sent off the vehicle (e.g., to a mapping system) so that a fleet owner/manager, for example, may monitor the load weight at different/points times and be alerted to changes in load weight. FIG. 5 shows an example of a map display 500 that may indicate different weight change alerts for the load weight at different points in time for a vehicle at different locations. As can be seen in FIG. 5, there was a weight change alert at stop 1, where the weight of the vehicle became overloaded. Then, there was a load weight change at stop 2, where the load weight became a medium load. In cases where this loading/unloading was unauthorized or unexpected, the fleet owners/managers may take appropriate action.

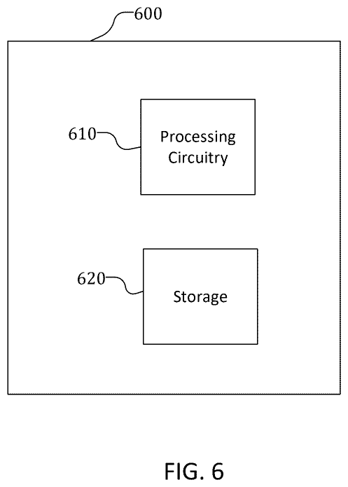

FIG. 6 is a schematic drawing illustrating a device 600 for estimating the load on a vehicle based on operating parameters, rather than with weight sensors. Device 600 may include any of the features of the load weight estimation described above. The load weight estimation of FIG. 6 may be implemented as a device, a method, and/or a computer readable medium that, when executed, performs the features of the load weight estimation described above. It should be understood that device 600 is only an example, and other configurations may be possible that include, for example, different components or additional components.

Device 600 includes processing circuitry 610 connected to storage 620. In addition to or in combination with any of the features described in the following paragraphs, processing circuitry 610 is configured to obtain an engine torque and a velocity of a vehicle when it is in motion. In addition to or in combination with any of the features described in the following paragraphs, processing circuitry 610 is configured to determine, based on the engine torque and the velocity, an estimate of a load weight on the vehicle. In addition to or in combination with any of the features described in the following paragraphs, processing circuitry 600 is configured to generate an instruction based on the estimate of the load weight.

Furthermore, in addition to or in combination with any of the features described in this or the previous paragraph, processing circuitry 610 may be configured to determine the estimate of the load weight based on a determination (e.g., an algorithm) that relates the engine torque and the velocity to the load weight of the vehicle. Furthermore, in addition to or in combination with any of the features described in this or the previous paragraph, the determination may comprise a machine learning model, wherein the engine torque and the velocity are inputs into the machine learning model and the estimate of the load weight are outputs of the machine learning model. Furthermore, in addition to or in combination with any of the features described in this or the previous paragraph, the determination may be configured to normalize the estimate of the load weight based on an operating parameter of the vehicle. Furthermore, in addition to or in combination with any of the features described in this or the previous paragraph, the determination may include a factor multiplied by the engine torque divided by the velocity. Furthermore, in addition to or in combination with any of the features described in this or the previous paragraph, the factor may be a constant (e.g., about 10 or 2322/5252). Furthermore, in addition to or in combination with any of the features described in this or the previous paragraph, the factor may be a variable that depends on an operating parameter of the vehicle.

Furthermore, in addition to or in combination with any of the features described in this or the previous two paragraphs, the operating parameter may include at least one of: a tire pressure of the vehicle, a pose of the vehicle, an acceleration of the vehicle, a geographic location of the vehicle, a road geometry of a road on which the vehicle is operating, an ambient temperature around the vehicle, a road condition of the road on which the vehicle is operating, and an engine temperature of the vehicle. Furthermore, in addition to or in combination with any of the features described in this or the previous two paragraphs, processing circuitry 610 may be further configured to adjust the estimate of the load weight based on a relationship between a measured operating parameter of the vehicle and a calibrated value related to the estimate of the load weight. Furthermore, in addition to or in combination with any of the features described in this or the previous two paragraphs, the measured operating parameter may include sensor measurements of one or more of the operating parameters (e.g., a tire pressure of the vehicle, a pose of the vehicle, an acceleration of the vehicle, a geographic location of the vehicle, a road geometry of a road on which the vehicle is operating, an ambient temperature around the vehicle, a road condition of the road on which the vehicle is operating, and an engine temperature of the vehicle, etc.).

Furthermore, in addition to or in combination with any of the features described in this or the previous three paragraphs, the engine torque and the velocity of the vehicle may include operating parameters of the vehicle received from a network controller (e.g., a CAN bus) of the vehicle. Furthermore, in addition to or in combination with any of the features described in this or the previous three paragraphs, processing circuitry 610 may be configured to determine the estimate of the load weight based on a transitional signal that indicates a change in a parametric parameter over time. Furthermore, in addition to or in combination with any of the features described in this or the previous three paragraphs, the transitional signal may be received from a pressure sensor that indicates the change in a pressure at a hitching point between the vehicle and a trailer that is carrying the load weight, wherein the parametric parameter comprises the pressure at the hitching point. Furthermore, in addition to or in combination with any of the features described in this or the previous three paragraphs, parametric change may include a change in an acceleration of the vehicle over time, wherein the estimate of the load weight is based on a width of (e.g., amount of time for) a transition that deviates from a starting acceleration and returns to the starting acceleration.

Furthermore, in addition to or in combination with any of the features described in this or the previous four paragraphs, processing circuitry 610 may be configured to determine the estimate of the load weight based on an unloaded weight of the vehicle. Furthermore, in addition to or in combination with any of the features described in this or the previous four paragraphs, wherein the estimate of the load weight may include an estimated total weight of the vehicle less the unloaded weight. Furthermore, in addition to or in combination with any of the features described in this or the previous four paragraphs, the instruction may include an indication of whether there is a change in the estimate of the load weight over time. Furthermore, in addition to or in combination with any of the features described in this or the previous four paragraphs, the indication may include whether the change satisfies a predefined criterion for a magnitude of the change. Furthermore, in addition to or in combination with any of the features described in this or the previous four paragraphs, the instruction may include a limit to operation of the vehicle corresponding to the load weight.

Furthermore, in addition to or in combination with any of the features described in this or the previous five paragraphs, the limit to the operation may include a route restriction for the vehicle to routes that permit load weights at or above the estimate of the load weight. Furthermore, in addition to or in combination with any of the features described in this or the previous five paragraphs, the operation may include a velocity restriction for the vehicle corresponding to the estimate of the load weight. Furthermore, in addition to or in combination with any of the features described in this or the previous five paragraphs, the operation may include an acceleration restriction for the vehicle corresponding to the estimate of the load weight. Furthermore, in addition to or in combination with any of the features described in this or the previous five paragraphs, the estimate of the load weight may include a range within which the estimate of the load weight falls.

Furthermore, in addition to or in combination with any of the features described in this or the previous six paragraphs, processing circuitry 610 may be further configured to determine a permitted operation that indicates whether a set of operating parameters satisfies a predefined criterion for calculating the estimate of the load weight, wherein the processor is further configured to report an error of the estimate of the load weight based the permitted operation and whether the set of operating parameters satisfies the predefined criterion. Furthermore, in addition to or in combination with any of the features described in this or the previous six paragraphs, the set of operating parameters may include a tire pressure of the vehicle, wherein the predefined criterion comprises a range of tire pressures, wherein the permitted operation indicates whether the tire pressure is within the range of tire pressures. Furthermore, in addition to or in combination with any of the features described in this or the previous six paragraphs, the set of operating parameters may include a pose of the vehicle, wherein the predefined criterion comprises a range of poses, wherein the permitted operation indicates whether the pose is within the range of poses (e.g., on a flat surface/straight road).

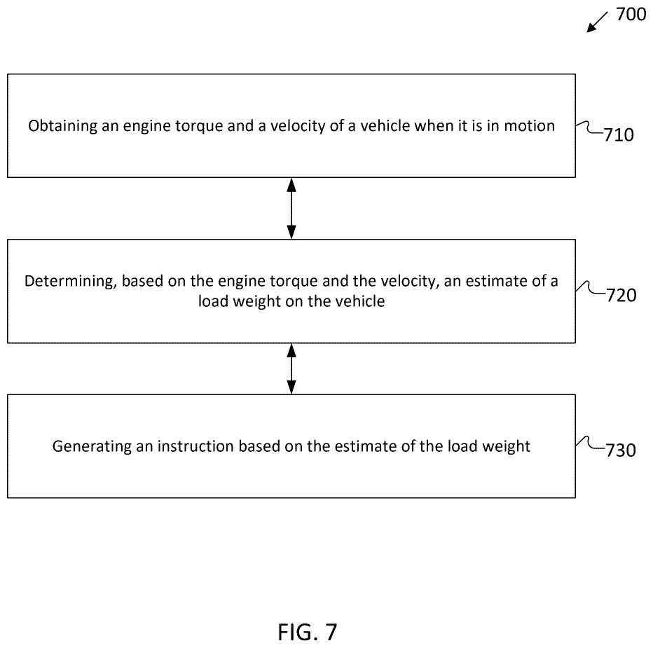

FIG. 7 depicts a schematic flow diagram of a method 700 for estimating the load on a vehicle based on operating parameters, rather than with weight sensors. Method 700 may implement any of the features of the load weight estimation described above.

Method 700 includes, in 710, obtaining an engine torque and a velocity of a vehicle when it is in motion. Method 700 also includes, in 720, determining, based on the engine torque and the velocity, an estimate of a load weight on the vehicle. Method 700 also includes, in 730, generating an instruction based on the estimate of the load weight.

In the following, various examples are provided that may include one or more features of the load weight estimation discussed above. It may be intended that aspects described in relation to the devices may apply also to the described method(s), and vice versa.

Example 1 is a device including a processor configured to obtain an engine torque and a velocity of a vehicle when it is in motion. The processor is also configured to determine, based on the engine torque and the velocity, an estimate of a load weight on the vehicle. The processor is also configured to generate an instruction based on the estimate of the load weight.

Example 1 is the device of example 0, wherein the processor is configured to determine the estimate of the load weight based on a determination (e.g., an algorithm) that relates the engine torque and the velocity to the load weight of the vehicle.

Example 2 is the device of example 1, wherein the determination includes a machine learning model, wherein the engine torque and the velocity are inputs into the machine learning model and the estimate of the load weight are outputs of the machine learning model.

Example 3 is the device of any one of examples 1 or 2, wherein the determination comprises normalizing the estimate of the load weight based on an operating parameter of the vehicle.

Example 4 is the device of any one of examples 1 to 3, wherein the determination includes a factor multiplied by the engine torque divided by the velocity.

Example 5 is the device of example 4, wherein the factor is a constant.

Example 6 is the device of example 5, wherein the constant is about 10 (e.g., 2322/5252).

Example 7 is the device of example 4, wherein the factor is a variable that depends on an operating parameter of the vehicle.

Example 8 is the device of any one of examples 3 to 7, wherein the operating parameter includes at least one of: a tire pressure of the vehicle, a pose of the vehicle, an acceleration of the vehicle, a geographic location of the vehicle, a road geometry of a road on which the vehicle is operating, an ambient temperature around the vehicle, a road condition of the road on which the vehicle is operating, and an engine temperature of the vehicle.

Example 9 is the device of any one of examples 0 to 8, wherein the processor is further configured to adjust the estimate of the load weight based on a relationship between a measured operating parameter of the vehicle and a calibrated value related to the estimate of the load weight.

Example 10 is the device of example 9, wherein the measured operating parameter includes sensor measurements of one or more of operating parameters including, as examples, a tire pressure of the vehicle, a pose of the vehicle, an acceleration of the vehicle, a geographic location of the vehicle, a road geometry of a road on which the vehicle is operating, an ambient temperature around the vehicle, a road condition of the road on which the vehicle is operating, and an engine temperature of the vehicle.

Example 11 is the device of any one of examples 0 to 10, wherein the engine torque and the velocity of the vehicle include operating parameters of the vehicle received from a network controller (e.g., a CAN bus) of the vehicle.

Example 12 is the device of any one of examples 0 to 11, wherein the processor is configured to determine the estimate of the load weight based on a transitional signal that indicates a change in a parametric parameter over time.

Example 13 is the device of example 12, wherein the transitional signal is received from a pressure sensor that indicates the change in a pressure at a hitching point between the vehicle and a trailer that is carrying the load weight, wherein the parametric parameter includes the pressure at the hitching point.

Example 14 is the device of example 13, wherein the parametric change includes a change in an acceleration of the vehicle over time, wherein the estimate of the load weight is based on a width of (e.g., amount of time for) a transition that deviates from a starting acceleration and returns to the starting acceleration.

Example 15 is the device of any one of examples 0 to 14, wherein the processor is configured to determine the estimate of the load weight based on an unloaded weight of the vehicle.

Example 16 is the device of example 15, wherein the estimate of the load weight includes an estimated total weight of the vehicle less the unloaded weight.

Example 17 is the device of any one of examples 0 to 16, wherein the instruction includes an indication of whether there is a change in the estimate of the load weight over time.

Example 18 is the device of example 17, wherein the indication includes whether the change satisfies a predefined criterion for a magnitude of the change.

Example 19 is the device of any one of examples 0 to 18, wherein the instruction includes a limit to operation of the vehicle corresponding to the load weight.

Example 20 is the device of example 19, wherein the limit to the operation includes a route restriction for the vehicle to routes that permit load weights at or above the estimate of the load weight.

Example 21 is the device of example 19, wherein the limit to the operation includes a velocity restriction for the vehicle corresponding to the estimate of the load weight.

Example 22 is the device of example 19, wherein the limit to the operation includes an acceleration restriction for the vehicle corresponding to the estimate of the load weight.

Example 23 is the device of any one of examples 0 to 22, wherein the estimate of the load weight includes a range within which the estimate of the load weight falls.

Example 24 is the device of any one of examples 0 to 23, wherein the processor is further configured to determine a permitted operation that indicates whether a set of operating parameters satisfies a predefined criterion for calculating the estimate of the load weight, wherein the processor is further configured to report an error of the estimate of the load weight based the permitted operation and whether the set of operating parameters satisfies the predefined criterion.

Example 25 is the device of example 24, wherein the set of operating parameters includes a tire pressure of the vehicle, wherein the predefined criterion includes a range of tire pressures, wherein the permitted operation indicates whether the tire pressure is within the range of tire pressures.

Example 26 is the device of example 25, wherein the set of operating parameters includes a pose of the vehicle, wherein the predefined criterion includes a range of poses, wherein the permitted operation indicates whether the pose is within the range of poses (e.g., on a flat surface/straight road).

Example 27 is a method that includes obtaining an engine torque and a velocity of a vehicle when it is in motion. The method also includes determining, based on the engine torque and the velocity, an estimate of a load weight on the vehicle. The method also includes generating an instruction based on the estimate of the load weight.

Example 28 is the method of example 27, wherein the method also includes determining the estimate of the load weight based on the determination that relates the engine torque and the velocity to the load weight of the vehicle.

Example 29 is the method of example 28, wherein the determination includes a machine learning model, wherein the engine torque and the velocity are inputs into the machine learning model and the estimate of the load weight are outputs of the machine learning model.

Example 30 is the method of any one of examples 28 or 29, wherein the determination comprises normalizing the estimate of the load weight based on an operating parameter of the vehicle.

Example 31 is the method of any one of examples 28 to 30, wherein the determination includes a factor multiplied by the engine torque divided by the velocity.

Example 32 is the method of example 31, wherein the factor is a constant.

Example 33 is the method of example 32, wherein the constant is about 10 (e.g., 2322/5252).

Example 34 is the method of example 31, wherein the factor is a variable that depends on an operating parameter of the vehicle.

Example 35 is the method of any one of examples 30 to 34, wherein the operating parameter includes at least one of: a tire pressure of the vehicle, a pose of the vehicle, an acceleration of the vehicle, a geographic location of the vehicle, a road geometry of a road on which the vehicle is operating, an ambient temperature around the vehicle, a road condition of the road on which the vehicle is operating, and an engine temperature of the vehicle.

Example 36 is the method of any one of examples 27 to 35, wherein the method further includes adjusting the estimate of the load weight based on a relationship between a measured operating parameter of the vehicle and a calibrated value related to the estimate of the load weight.

Example 37 is the method of example 36, wherein the measured operating parameter includes sensor measurements of one or more of operating parameters including, as examples, a tire pressure of the vehicle, a pose of the vehicle, an acceleration of the vehicle, a geographic location of the vehicle, a road geometry of a road on which the vehicle is operating, an ambient temperature around the vehicle, a road condition of the road on which the vehicle is operating, and an engine temperature of the vehicle.

Example 38 is the method of any one of examples 27 to 37, wherein the engine torque and the velocity of the vehicle include operating parameters of the vehicle received from a network controller (e.g., a CAN bus) of the vehicle.

Example 39 is the method of any one of examples 27 to 38, the method further including determining the estimate of the load weight based on a transitional signal that indicates a change in a parametric parameter over time.

Example 40 is the method of example 39, wherein the transitional signal is received from a pressure sensor that indicates the change in a pressure at a hitching point between the vehicle and a trailer that is carrying the load weight, wherein the parametric parameter includes the pressure at the hitching point.

Example 41 is the method of example 40, wherein the parametric change includes a change in an acceleration of the vehicle over time, wherein the estimate of the load weight is based on a width of (e.g., amount of time for) a transition that deviates from a starting acceleration and returns to the starting acceleration.

Example 42 is the method of any one of examples 27 to 41, the method further including determining the estimate of the load weight based on an unloaded weight of the vehicle.

Example 43 is the method of example 42, wherein the estimate of the load weight includes an estimated total weight of the vehicle less the unloaded weight.

Example 44 is the method of any one of examples 27 to 43, wherein the instruction includes an indication of whether there is a change in the estimate of the load weight over time.

Example 45 is the method of example 44, wherein the indication includes whether the change satisfies a predefined criterion for a magnitude of the change.

Example 46 is the method of any one of examples 27 to 45, wherein the instruction includes a limit to operation of the vehicle corresponding to the load weight.

Example 47 is the method of example 46, wherein the limit to the operation includes a route restriction for the vehicle to routes that permit load weights at or above the estimate of the load weight.

Example 48 is the method of example 46, wherein the limit to the operation includes a velocity restriction for the vehicle corresponding to the estimate of the load weight.

Example 49 is the method of example 46, wherein the limit to the operation includes an acceleration restriction for the vehicle corresponding to the estimate of the load weight.

Example 50 is the method of any one of examples 27 to 49, wherein the estimate of the load weight includes a range within which the estimate of the load weight falls.

Example 51 is the method of any one of examples 27 to 50, the method further including determining a permitted operation that indicates whether a set of operating parameters satisfies a predefined criterion for calculating the estimate of the load weight, wherein the method further includes reporting an error of the estimate of the load weight based the permitted operation and whether the set of operating parameters satisfies the predefined criterion.

Example 52 is the method of example 51, wherein the set of operating parameters includes a tire pressure of the vehicle, wherein the predefined criterion includes a range of tire pressures, wherein the permitted operation indicates whether the tire pressure is within the range of tire pressures.

Example 53 is the method of example 52, wherein the set of operating parameters includes a pose of the vehicle, wherein the predefined criterion includes a range of poses, wherein the permitted operation indicates whether the pose is within the range of poses (e.g., on a flat surface/straight road).

Example 54 is an apparatus that includes a means for obtaining an engine torque and a velocity of a vehicle when it is in motion. The apparatus also includes a means for determining, based on the engine torque and the velocity, an estimate of a load weight on the vehicle. The apparatus also includes a means for generating an instruction based on the estimate of the load weight.

Example 55 is the apparatus of example 54, wherein the apparatus also includes a means for determining the estimate of the load weight based on the determination that relates the engine torque and the velocity to the load weight of the vehicle.

Example 56 is the apparatus of example 55, wherein the determination includes a machine learning model, wherein the engine torque and the velocity are inputs into the machine learning model and the estimate of the load weight are outputs of the machine learning model.

Example 57 is the apparatus of any one of examples 55 or 56, wherein the determination comprises normalizing the estimate of the load weight based on an operating parameter of the vehicle.

Example 58 is the apparatus of any one of examples 55 to 57, wherein the determination includes a factor multiplied by the engine torque divided by the velocity.

Example 59 is the apparatus of example 58, wherein the factor is a constant.

Example 60 is the apparatus of example 59, wherein the constant is about 10 (e.g., 2322/5252).

Example 61 is the apparatus of example 58, wherein the factor is a variable that depends on an operating parameter of the vehicle.

Example 62 is the apparatus of any one of examples 57 to 61, wherein the operating parameter includes at least one of: a tire pressure of the vehicle, a pose of the vehicle, an acceleration of the vehicle, a geographic location of the vehicle, a road geometry of a road on which the vehicle is operating, an ambient temperature around the vehicle, a road condition of the road on which the vehicle is operating, and an engine temperature of the vehicle.

Example 63 is the apparatus of any one of examples 54 to 62, wherein the apparatus further includes a means for adjusting the estimate of the load weight based on a relationship between a measured operating parameter of the vehicle and a calibrated value related to the estimate of the load weight.

Example 64 is the apparatus of example 63, wherein the measured operating parameter includes sensor measurements of one or more of operating parameters including, as examples, a tire pressure of the vehicle, a pose of the vehicle, an acceleration of the vehicle, a geographic location of the vehicle, a road geometry of a road on which the vehicle is operating, an ambient temperature around the vehicle, a road condition of the road on which the vehicle is operating, and an engine temperature of the vehicle.

Example 65 is the apparatus of any one of examples 54 to 64, wherein the engine torque and the velocity of the vehicle include operating parameters of the vehicle received from a network controller (e.g., a CAN bus) of the vehicle.

Example 66 is the apparatus of any one of examples 54 to 65, the apparatus further including a means for determining the estimate of the load weight based on a transitional signal that indicates a change in a parametric parameter over time.

Example 67 is the apparatus of example 66, wherein the transitional signal is received from a pressure sensor that indicates the change in a pressure at a hitching point between the vehicle and a trailer that is carrying the load weight, wherein the parametric parameter includes the pressure at the hitching point.

Example 68 is the apparatus of example 67, wherein the parametric change includes a change in an acceleration of the vehicle over time, wherein the estimate of the load weight is based on a width of (e.g., amount of time for) a transition that deviates from a starting acceleration and returns to the starting acceleration.

Example 69 is the apparatus of any one of examples 54 to 68, the apparatus further including a means for determining the estimate of the load weight based on an unloaded weight of the vehicle.

Example 70 is the apparatus of example 69, wherein the estimate of the load weight includes an estimated total weight of the vehicle less the unloaded weight.

Example 71 is the apparatus of any one of examples 54 to 70, wherein the instruction includes an indication of whether there is a change in the estimate of the load weight over time.

Example 72 is the apparatus of example 71, wherein the indication includes whether the change satisfies a predefined criterion for a magnitude of the change.

Example 73 is the apparatus of any one of examples 54 to 72, wherein the instruction includes a limit to operation of the vehicle corresponding to the load weight.

Example 74 is the apparatus of example 73, wherein the limit to the operation includes a route restriction for the vehicle to routes that permit load weights at or above the estimate of the load weight.

Example 75 is the apparatus of example 73, wherein the limit to the operation includes a velocity restriction for the vehicle corresponding to the estimate of the load weight.

Example 76 is the apparatus of example 73, wherein the limit to the operation includes an acceleration restriction for the vehicle corresponding to the estimate of the load weight.

Example 77 is the apparatus of any one of examples 54 to 76, wherein the estimate of the load weight includes a range within which the estimate of the load weight falls.

Example 78 is the apparatus of any one of examples 54 to 77, the apparatus further including a means for determining a permitted operation that indicates whether a set of operating parameters satisfies a predefined criterion for calculating the estimate of the load weight, wherein apparatus further includes a means for reporting an error of the estimate of the load weight based the permitted operation and whether the set of operating parameters satisfies the predefined criterion.

Example 79 is the apparatus of example 78, wherein the set of operating parameters includes a tire pressure of the vehicle, wherein the predefined criterion includes a range of tire pressures, wherein the permitted operation indicates whether the tire pressure is within the range of tire pressures.

Example 80 is the apparatus of example 79, wherein the set of operating parameters includes a pose of the vehicle, wherein the predefined criterion includes a range of poses, wherein the permitted operation indicates whether the pose is within the range of poses (e.g., on a flat surface/straight road).

Example 81 is a non-transitory, computer-readable medium including instructions that, when executed, cause one or more processors to obtain an engine torque and a velocity of a vehicle when it is in motion. The instructions also cause the one or more processors to determine, based on the engine torque and the velocity, an estimate of a load weight on the vehicle. The instructions also cause the one or more processors to generate an instruction based on the estimate of the load weight.

Example 82 is the non-transitory, computer-readable medium of example 81, wherein the instructions also cause the one or more processors to determine the estimate of the load weight based on a determination (e.g., an algorithm) that relates the engine torque and the velocity to the load weight of the vehicle.

Example 83 is the non-transitory, computer-readable medium of example 82, wherein the determination includes a machine learning model, wherein the engine torque and the velocity are inputs into the machine learning model and the estimate of the load weight are outputs of the machine learning model.

Example 84 is the non-transitory, computer-readable medium of any one of examples 82 or 83, wherein the determination comprises normalizing the estimate of the load weight based on an operating parameter of the vehicle.

Example 85 is the non-transitory, computer-readable medium of any one of examples 82 to 84, wherein the determination includes a factor multiplied by the engine torque divided by the velocity.

Example 86 is the non-transitory, computer-readable medium of example 85, wherein the factor is a constant.

Example 87 is the non-transitory, computer-readable medium of example 86, wherein the constant is about 10 (e.g., 2322/5252).

Example 88 is the non-transitory, computer-readable medium of example 85, wherein the factor is a variable that depends on an operating parameter of the vehicle.

Example 89 is the non-transitory, computer-readable medium of any one of examples 84 to 88, wherein the operating parameter includes at least one of: a tire pressure of the vehicle, a pose of the vehicle, an acceleration of the vehicle, a geographic location of the vehicle, a road geometry of a road on which the vehicle is operating, an ambient temperature around the vehicle, a road condition of the road on which the vehicle is operating, and an engine temperature of the vehicle.

Example 90 is the non-transitory, computer-readable medium of any one of examples 81 to 89, wherein the instructions also cause the one or more processors to adjust the estimate of the load weight based on a relationship between a measured operating parameter of the vehicle and a calibrated value related to the estimate of the load weight.

Example 91 is the non-transitory, computer-readable medium of example 90, wherein the measured operating parameter includes sensor measurements of one or more of operating parameters including, as examples, a tire pressure of the vehicle, a pose of the vehicle, an acceleration of the vehicle, a geographic location of the vehicle, a road geometry of a road on which the vehicle is operating, an ambient temperature around the vehicle, a road condition of the road on which the vehicle is operating, and an engine temperature of the vehicle.

Example 92 is the non-transitory, computer-readable medium of any one of examples 81 to 91, wherein the engine torque and the velocity of the vehicle include operating parameters of the vehicle received from a network controller (e.g., a CAN bus) of the vehicle.

Example 93 is the non-transitory, computer-readable medium of any one of examples 81 to 92, wherein the instructions also cause the one or more processors to determine the estimate of the load weight based on a transitional signal that indicates a change in a parametric parameter over time.

Example 94 is the non-transitory, computer-readable medium of example 93, wherein the transitional signal is received from a pressure sensor that indicates the change in a pressure at a hitching point between the vehicle and a trailer that is carrying the load weight, wherein the parametric parameter includes the pressure at the hitching point.

Example 95 is the non-transitory, computer-readable medium of example 94, wherein the parametric change includes a change in an acceleration of the vehicle over time, wherein the estimate of the load weight is based on a width of (e.g., amount of time for) a transition that deviates from a starting acceleration and returns to the starting acceleration.

Example 96 is the non-transitory, computer-readable medium of any one of examples 81 to 95, wherein the instructions also cause the one or more processors to determine the estimate of the load weight based on an unloaded weight of the vehicle.

Example 97 is the non-transitory, computer-readable medium of example 96, wherein the estimate of the load weight includes an estimated total weight of the vehicle less the unloaded weight.

Example 98 is the non-transitory, computer-readable medium of any one of examples 81 to 97, wherein the instruction includes an indication of whether there is a change in the estimate of the load weight over time.

Example 99 is the non-transitory, computer-readable medium of example 98, wherein the indication includes whether the change satisfies a predefined criterion for a magnitude of the change.

Example 100 is the non-transitory, computer-readable medium of any one of examples 81 to 99, wherein the instruction includes a limit to operation of the vehicle corresponding to the load weight.

Example 101 is the non-transitory, computer-readable medium of example 100, wherein the limit to the operation includes a route restriction for the vehicle to routes that permit load weights at or above the estimate of the load weight.

Example 102 is the non-transitory, computer-readable medium of example 100, wherein the limit to the operation includes a velocity restriction for the vehicle corresponding to the estimate of the load weight.

Example 103 is the non-transitory, computer-readable medium of example 100, wherein the limit to the operation includes an acceleration restriction for the vehicle corresponding to the estimate of the load weight.

Example 104 is the non-transitory, computer-readable medium of any one of examples 81 to 103, wherein the estimate of the load weight includes a range within which the estimate of the load weight falls.

Example 105 is the non-transitory, computer-readable medium of any one of examples 81 to 104, wherein the instructions also cause the one or more processors to determine a permitted operation that indicates whether a set of operating parameters satisfies a predefined criterion for calculating the estimate of the load weight, wherein the instructions also cause the one or more processors to report an error of the estimate of the load weight based the permitted operation and whether the set of operating parameters satisfies the predefined criterion.

Example 106 is the non-transitory, computer-readable medium of example 105, wherein the set of operating parameters includes a tire pressure of the vehicle, wherein the predefined criterion includes a range of tire pressures, wherein the permitted operation indicates whether the tire pressure is within the range of tire pressures.

Example 107 is the non-transitory, computer-readable medium of example 106, wherein the set of operating parameters includes a pose of the vehicle, wherein the predefined criterion includes a range of poses, wherein the permitted operation indicates whether the pose is within the range of poses (e.g., on a flat surface/straight road).

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

Claimed is:

1. A device comprising a processor configured to:
obtain an engine torque and a velocity of a vehicle when it is in motion;
determine, based on the engine torque and the velocity, an estimate of a load weight on the vehicle; and
generate an instruction based on the estimate of the load weight.

2. The device of claim 1, wherein the estimate of the load weight is based on a determination that relates the engine torque and the velocity to the load weight of the vehicle.

3. The device of claim 2, wherein the determination comprises a machine learning model, wherein the engine torque and the velocity are inputs into the machine learning model and the estimate of the load weight are outputs of the machine learning model.

4. The device of claim 2, wherein the determination comprises normalizing the estimate of the load weight based on an operating parameter of the vehicle.

5. The device of claim 2, wherein the determination comprises a factor multiplied by the engine torque divided by the velocity.

6. The device of claim 5, wherein the factor is a constant.

7. The device of claim 6, wherein the constant is about 10.

8. The device of claim 5, wherein the factor is a variable that depends on an operating parameter of the vehicle.

9. The device of claim 4, wherein the operating parameter comprises at least one of: a tire pressure of the vehicle, a pose of the vehicle, an acceleration of the vehicle, a geographic location of the vehicle, a road geometry of a road on which the vehicle is operating, an ambient temperature around the vehicle, a road condition of the road on which the vehicle is operating, and an engine temperature of the vehicle.

10. The device of claim 1, wherein the processor is further configured to adjust the estimate of the load weight based on a relationship between a measured operating parameter of the vehicle and a calibrated value related to the estimate of the load weight.

11. The device of claim 1, wherein the engine torque and the velocity of the vehicle comprise operating parameters of the vehicle received from a network controller of the vehicle.

12. A non-transitory, computer-readable medium comprising instructions that, when executed, cause one or more processors to:
obtain an engine torque and a velocity of a vehicle when it is in motion;
determine, based on the engine torque and the velocity, an estimate of a load weight on the vehicle; and
generate an instruction message based on the estimate of the load weight.

13. The non-transitory, computer-readable medium of claim 12, wherein the instructions determine the estimate of the load weight based on a transitional signal that indicates a change in a parametric parameter over time.

14. The non-transitory, computer-readable medium of claim 13, wherein the transitional signal is received from a pressure sensor that indicates the change in a pressure at a hitching point between the vehicle and a trailer that is carrying the load weight, wherein the parametric parameter comprises the pressure at the hitching point.

15. The non-transitory, computer-readable medium of claim 13, wherein the change in the parametric parameter comprises an acceleration change of the vehicle over time, wherein the estimate of the load weight is based on a width of a transition that deviates from a starting acceleration and returns to the starting acceleration.

16. The non-transitory, computer-readable medium of claim 12, wherein the estimate of the load weight comprises an estimated total weight of the vehicle less an unloaded weight of the vehicle.

17. The non-transitory, computer-readable medium of claim 12, wherein the instruction message comprises an indication of whether there is a change in the estimate of the load weight over time, wherein the indication comprises whether the change satisfies a predefined criterion for a magnitude of the change.

18. The non-transitory, computer-readable medium of claim 12, wherein the instruction message comprises a limit to operation of the vehicle corresponding to the load weight, wherein the limit to the operation comprises:
a route restriction for the vehicle to routes that permit load weights at or above the estimate of the load weight;
a velocity restriction for the vehicle corresponding to the estimate of the load weight; or
an acceleration restriction for the vehicle corresponding to the estimate of the load weight.

19. An apparatus for estimating a load weight of a vehicle, the apparatus comprising:
a means for obtaining an engine torque and a velocity of a vehicle when it is in motion;
a means for determining, based on the engine torque and the velocity, an estimate of a load weight on the vehicle; and
a means for generating an instruction based on the estimate of the load weight.

20. The apparatus of claim 19, the apparatus further comprising a means for determining a permitted operation that indicates whether a set of operating parameters satisfies a predefined criterion for calculating the estimate of the load weight, wherein the apparatus further includes a means for reporting an error of the estimate of the load weight based the permitted operation and whether the set of operating parameters satisfies the predefined criterion.
